(19) United States
(12) Patent Application Publication
(10) Pub. No.: US 2013/0136019 A1
(43) Pub. Date: May 30, 2013

(54) FIELD WIRELESS SYSTEM

(71) Applicant: YOKOGAWA ELECTRIC CORPORATION, Tokyo (JP)

(72) Inventor: Naoyuki FUJIMOTO, Musashino-shi (JP)

(73) Assignee: YOKOGAWA ELECTRIC CORPORATION, Tokyo (JP)

(21) Appl. No.: 13/680,758

(22) Filed: Nov. 19, 2012

(30) Foreign Application Priority Data
Nov. 25, 2011 (JP) 2011-257355

(51) Int. Cl. H04W 24/02

(52) U.S. Cl. CPC H04W 24/02
USPC 370/252; 370/254

(57) ABSTRACT

A field wireless system may include a system manager that manages a wireless network including wireless field devices, and a backbone router that performs wireless communication with the wireless field devices. The system manager may include a network configuration collection unit that collects a connection configuration of the wireless network, and a path selection unit that selects relay paths for each of the wireless field devices that is a destination of a packet, based on the collected connection configuration. The backbone router may include a relay information storage unit that stores the selected relay paths, and a packet processing unit that replicates packets, each of which is destined for each of the wireless field devices, by the number of the stored relay paths, the packet processing unit storing information indicating a different relay path in each of the replicated packets.

### BACKGROUND OF THE INVENTION

1. Field of the Invention

The present invention relates to a field wireless system. Specifically, the present invention relates to a field wireless system suitable for monitoring of wireless field devices, as well as real-time control of the wireless field devices.

Priority is claimed on Japanese Patent Application No. 2011-257355, filed Nov. 25, 2011, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In recent years, a field wireless system, in which communication between a field device and a system on a control side is wirelessly performed, has been researched and developed, and also put to practical use. WirelessHART using wireless communication protocol for instrumentation proposed by the HART Association and ISA100.11a that is a wireless communication standard for industrial automation proposed by the ISA (International Society of Automation) are typical as standards for the field wireless system.

In WirelessHART, uses, such as, primarily, monitoring of wireless field devices, transmission of a process amount, and maintenance and inspection in which a request for a real-time property or reliability of data arrival is relatively low are assumed. On the other hand, ISA100.11a is assumed to be applied to even critical uses requiring a real-time property and robustness, such as control of wireless field devices, for example, a manipulation of an actuator.

FIG. 7 is a diagram illustrating a configuration example of a field wireless system to which ISA100.11a is applied in accordance with the related art. As illustrated in FIG. 7, the field wireless system includes a plurality of wireless field devices 400 (400a to 400h), a backbone router 380, a gateway 320, and a system manager 340. The plurality of wireless field devices 400 constitute a wireless network. Each of the wireless field devices 400 is a field device, such as a sensor or an actuator, having a wireless communication function. The plurality of wireless field devices 400 are arranged in a place such as a plant according to a use or a purpose. The wireless field device 400 can communicate with an adjacent wireless field device 400. Thus, a plurality of wireless field devices 400 constitute a mesh-shaped wireless network.

The field wireless system is connected to a control network, which is an upper network including a controller 300, via the gateway 320. The gateway 320 performs gateway processing between the control network and the wireless network. The gateway 320 exchanges packets with each of the wireless field devices 400 over the wireless network. In this case, each of the wireless field devices 400 becomes a target of communication with the gateway 320 and performs a process of relaying communication between another wireless field device 400 and the gateway 320.

The system manager 340 is a device responsible for control and management of operation of the wireless network. The system manager 340 sets a configuration of the wireless network. Specifically, the system manager 340 selects a communication path based on a connection status of the wireless field device 400, and sets the communication path in the backbone router 380.

The communication path is set in the backbone router 380 by the system manager 340. The backbone router 380 performs wireless communication with adjacent wireless field devices to perform interconnection between the gateway 320 and each wireless field device 400. In this case, transmission of packets along the communication path set by the system manager 340 (hereinafter referred to as routing) is performed.

For example, Japanese Unexamined Patent Application, First Publication No. 2011-13765 discloses a sensor network system having the function described above.

In the field wireless system shown in FIG. 7, for example, a packet containing a control command is assumed to be transmitted from the gateway 320 to the wireless field device 400e. That is, a destination of the packet is the wireless field device 400e. For example, a transmission path of the packet is assumed to be set by the system manager 340 as backbone router 380→wireless field device 400a→wireless field device 400c→wireless field device 400e, i.e., as a path indicated by a bold dotted line in FIG. 7. In this case, the wireless field device 400a and the wireless field device 400c are relay points and perform a process of relaying communication.

If the communication path and the relay points are normal, the packet is transmitted along the set path and arrives at the wireless field device 400e. However, for example, if a communication path between the wireless field device 400c and the wireless field device 400e is disconnected for any reason, the packet is unable to arrive at the wireless field device 400e.

Each of the wireless field devices 400 that are relay points has only a function of transmitting a packet to a relay destination that directly transmits the packet and a function of retransmitting the packet when failing to transmit the packet to the relay destination. Therefore, a device on an upstream side from the wireless field device 400c cannot immediately recognize that a path between the wireless field device 400c and the wireless field device 400e has been disconnected. For this reason, even after the communication path between the wireless field device 400c and the wireless field device 400e is disconnected, the packet destined for the wireless field device 400e is transmitted along such a disconnected communication path.

When the system manager 340 has a function of monitoring communication quality, if the system manager 340 detects disconnection of the communication path, the system manager 340 sets an alternative path. Then, the packet can arrive at the wireless field device 400e. Even in this case, packets transmitted while the disconnection of the communication path is being detected and the alternative path is being set do not arrive at the wireless field device 400e and are lost.

In the case of conventional communication for a monitoring purpose, effects of non-arrival or delayed arrival of a packet on a plant are not so great. However, in the case of a mission-critical communication purpose, such as continuous process control, since the effects of non-arrival or delayed arrival of a packet on a plant are great, it is necessary to prevent the non-arrival or delayed arrival of a packet as much as possible.

### SUMMARY

A field wireless system may include: a system manager that manages a wireless network including wireless field devices; and a backbone router that performs wireless communication with the wireless field devices. The system manager may include: a network configuration collection unit that collects a connection configuration of the wireless network; and a path selection unit that selects relay paths for each of the wireless field devices that is a destination of a packet, based on the connection configuration that has been collected. The backbone router may include: a relay information storage unit that stores the relay paths that have been selected; and a packet processing unit that replicates packets, each of which is destined for each of the wireless field devices, by the number of the relay paths that have been stored, the packet processing unit storing information indicating a different relay path in each of the packets that have been replicated.

The path selection unit may: take a plurality of paths from a set of candidate paths, as combinations; perform evaluation on each of the combinations by using an evaluation scheme, in which an evaluation increases as the number of overlaps of links between the wireless field devices on paths, which are included in each of the combinations, decreases; and select one of the combinations having a highest evaluation as the relay path.

The evaluation scheme may include: taking, as the evaluation, a step of incrementing a negative evaluation value for one overlapping wireless field device in the plurality of paths included in each of the combinations and incrementing a negative evaluation value for one link between the overlapping wireless field devices; and performing the evaluation on all of the combinations and selecting, as the relay path, one of the combinations having the smallest negative evaluation value.

If there are a plurality of combinations having the smallest evaluation value, then each of the combinations having a smaller total number of links between the wireless field devices on the paths, which is included in each of the combinations, may be selected as the relay path.

A field wireless system may include: wireless field devices; a system manager that manages a wireless network including the wireless field devices; and a backbone router that performs wireless communication with the wireless field devices. The system manager may include: a network configuration collection unit that collects a connection configuration of the wireless network; and a path selection unit that selects relay paths for each of the wireless field devices that is a destination of a packet, based on the connection configuration that has been collected. The backbone router may include: a relay information storage unit that stores the relay paths that have been selected; and a packet processing unit that replicates packets, each of which is destined for each of the wireless field devices, by the number of the relay paths that have been stored, the packet processing unit storing information indicating a different relay path in each of the packets that have been replicated. Each of the wireless field devices may discard a newly received packet if the wireless field device has received a packet having the same identifier when receiving packet destined for the own wireless field device.

The system manager may set, in each of the wireless field devices, a plurality of upper wireless field devices to which a packet destined for an upper network device is capable of being transmitted. The wireless field device may transmit the packet destined for an upper network device to one of the set upper wireless field devices, and transmit the packet to another set upper wireless field device when the transmission is incapable of being performed.

The system manager may store identification information of the wireless field devices included in the relay path, in the packet, in an order in which the packet passes through the wireless field devices.

Each of the wireless field devices may transmit the packet to another wireless field device based on the identification information stored in the received packet.

The system manager may define the relay path in a graph form and store the relay path in each of the wireless field devices as graph information.

Each of the wireless field devices may transmit the packet to another wireless field device according to the graph designated in the received packet by referring to the graph information stored in the own wireless field device.

A wireless network management method for managing a wireless network including wireless field devices may include: collecting a connection configuration of the wireless network; selecting relay paths for each of the wireless field devices that is a destination of a packet based on the connection configuration that has been collected; storing the relay paths that have been selected; replicating packets, each of which is destined for the wireless field device, by the number of relay paths that have been stored; and storing information indicating a different relay path in each of the packets that have been replicated.

The wireless network management method may further include: taking a plurality of paths from a set of candidate paths, as combinations; performing evaluation on each of the combinations by using an evaluation scheme, in which an evaluation increases as the number of overlaps of the links between the wireless field devices on paths, which are included in each of the combinations, decreases; and selecting one of the combinations having a highest evaluation as the relay path.

The evaluation scheme may include: taking, as the evaluation, a step of incrementing a negative evaluation value for one overlapping wireless field device in the plurality of paths included in each of the combinations and incrementing a negative evaluation value for one link between the overlapping wireless field devices; and performing the evaluation on all of the combinations and selecting, as the relay path, one of the combinations having the smallest negative evaluation value.

If there are a plurality of combinations having the smallest evaluation value, then each of the combinations having a smaller total number of links between the wireless field devices on the paths, which is included in the combination, may be selected as the relay path.

The wireless network management method may further include: discarding a newly received packet if receiving a packet having the same identifier when receiving the packet destined for own wireless field device.

The wireless network management method may further include: setting, in the wireless field device, a plurality of upper wireless field devices to which a packet destined for an upper network device is capable of being transmitted; and transmitting the packet destined for an upper network device to one of the set upper wireless field devices, and transmitting the packet to another set upper wireless field device if the transmission is incapable of being performed.

The wireless network management method may further include: storing identification information of the wireless field devices included in the relay path, in the packet, in an order in which the packet passes through the wireless field devices.

The wireless network management method may further include: transmitting the packet to another wireless field device based on the identification information stored in the received packet.

The wireless network management method may further include: defining the relay path in a graph form and storing the relay path in each of the wireless field devices as graph information.

The wireless network management method may further include: transmitting the packet to another wireless field device according to the graph designated in the received packet by referring to the graph information stored in each of the wireless field devices.

According to the present invention, it is possible to increase reliability of packet arrival in a field wireless system.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a diagram illustrating a configuration example of a field wireless system in accordance with the first preferred embodiment of the present invention;

FIG. 2 is a block diagram illustrating functional configurations of the gateway 120, the system manager 140, the backbone router 180, and the wireless field devices 200 in the field wireless system in accordance with the first preferred embodiment of the present invention;

FIG. 3 is a flowchart illustrating the path selection operation of the system manager in the field wireless system in accordance with the first preferred embodiment of the present invention;

FIG. 4 is a flowchart illustrating a routing operation of the backbone router included in the field wireless system in accordance with the first preferred embodiment of the present invention;

FIG. 5 is a flowchart illustrating a packet reception operation of the wireless field device included in the field wireless system in accordance with the first preferred embodiment of the present invention;

FIG. 6 is a diagram illustrating another configuration example of the field wireless system in accordance with the first preferred embodiment of the present invention; and

FIG. 7 is a diagram illustrating a configuration example of a field wireless system to which ISA100.11a is applied in accordance with the related art.

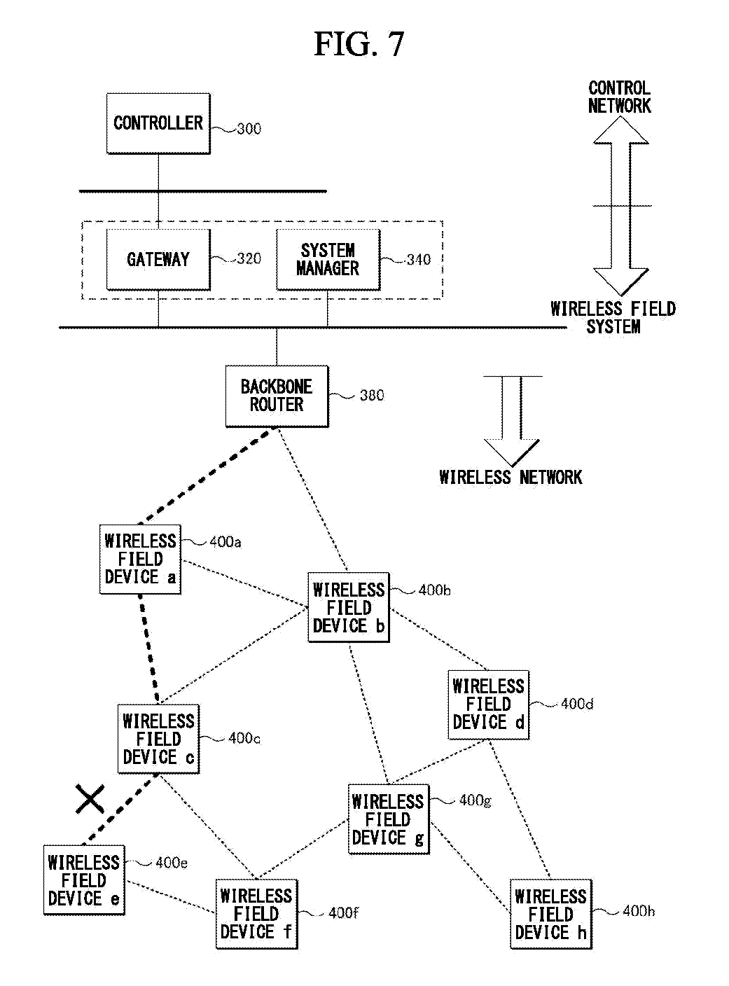

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated herein for explanatory purposes.

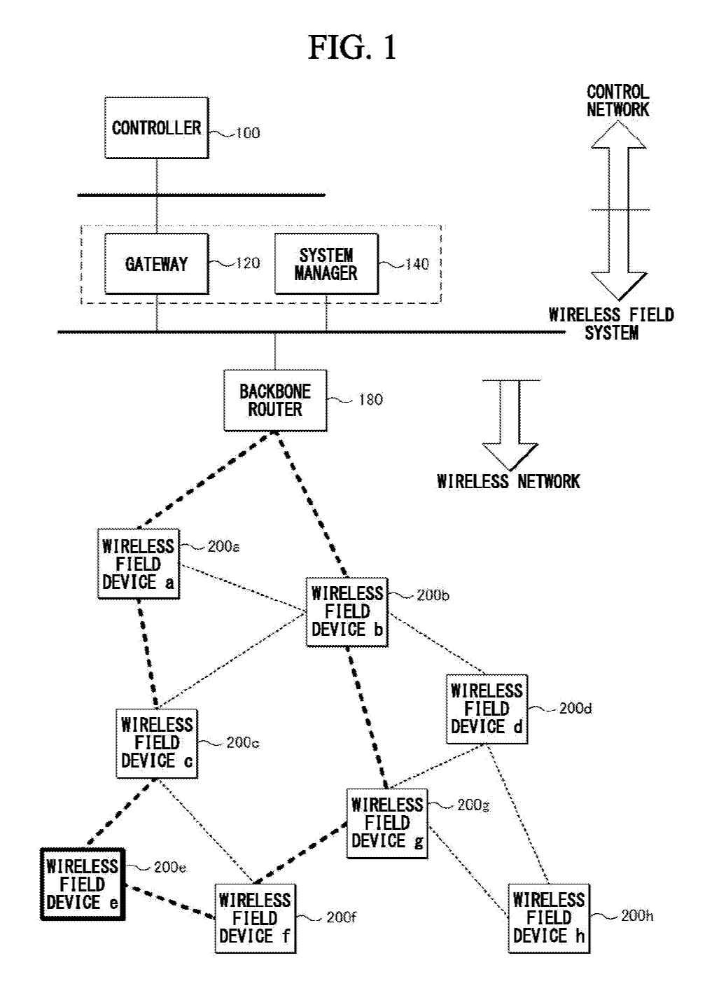

A first preferred embodiment of the present invention will be described with reference to the drawings. FIG. 1 is a diagram illustrating a configuration example of a field wireless system in accordance with the first preferred embodiment of the present invention. As illustrated in FIG. 1, in the field wireless system, a plurality of wireless field devices 200 (200a to 200h) constitute a wireless network. Each of the wireless field devices 200 is a field device, such as a sensor or an actuator, having a wireless communication function. The plurality of wireless field devices 200 are arranged in a place such as a plant according to a use or a purpose.

The wireless field device 200 can communicate with an adjacent wireless field device 200 by using protocol conforming to the ISA100.11a. Thus, the plurality of wireless field devices 200 constitute a mesh-shaped wireless network. Here, the wireless communication standard is not limited to ISA100.11a, and other wireless communication standards may be used.

Also, the field wireless system includes a gateway 120, a system manager 140, and a backbone router 180. The field wireless system is connected to a control network, which is an upper network including a controller 100, via the gateway 120.

The gateway 120 performs gateway processing between the control network and the wireless network. The gateway 120 exchanges a packet with each of the wireless field devices 200 over the wireless network. In this case, each of the wireless field devices 200 is a target of communication with the gateway 120 and performs a process of relaying communication between another wireless field device 200 and the gateway 120.

The system manager 140 is a device responsible for control and management of operation of the wireless network. The system manager 140 sets a configuration of the wireless network. Specifically, the system manager 140 selects a communication path based on a connection status of the wireless field device 200 and sets a communication path in the backbone router 180.

The communication path is set in the backbone router 180 by the system manager 140. The backbone router 180 performs wireless communication with an adjacent wireless field device to perform interconnection between the gateway 120 and each wireless field device 200. In this case, transmission of packets along the communication path set by the system manager 140 (hereinafter referred to as routing) is performed.

The controller 100 is an upper system, such as a DCS (Distributed Control System) or a device management system. The controller 100 performs control of monitoring of a status of the wireless field device 200 and adjustment of the device parameters and the like, and collects a process amount generated by the wireless field device 200, diagnostic results, and the like.

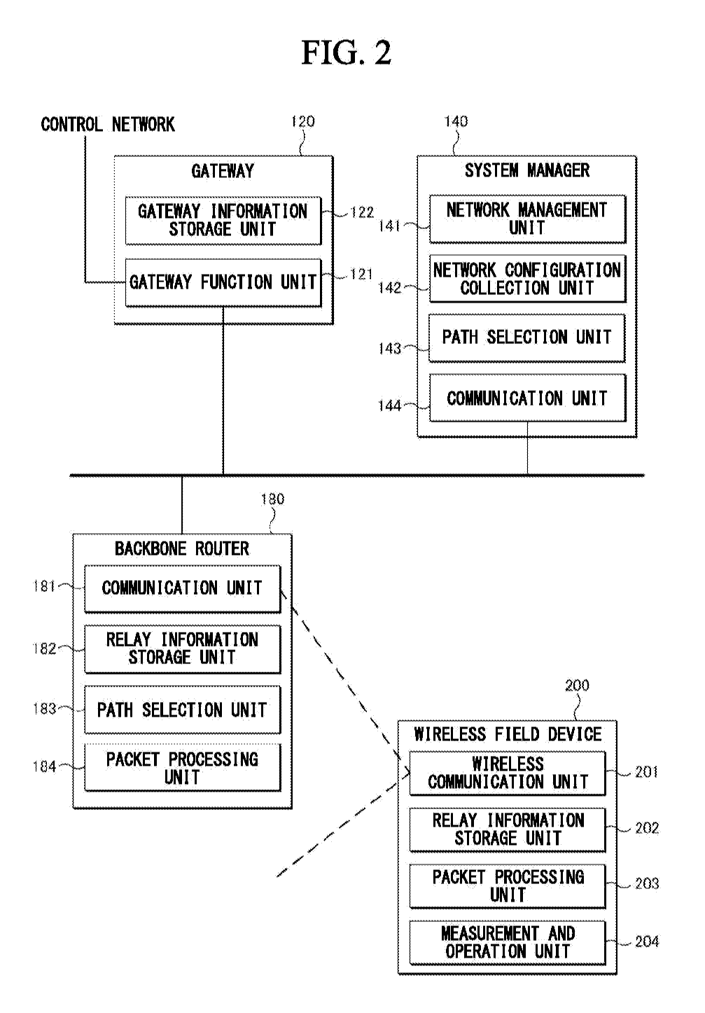

FIG. 2 is a block diagram illustrating functional configurations of the gateway 120, the system manager 140, the backbone router 180, and the wireless field devices 200 in the field wireless system in accordance with the first preferred embodiment of the present invention. For the wireless field devices 200, only one wireless field device is illustrated in FIG. 2.

Here, a description will be given focusing on packet transmission from the gateway 120 to the wireless field device 200 (hereinafter referred to as a downlink direction). In addition to setting of operation parameters, a packet transmitted from the gateway 120 to the wireless field device 200 contains a time-critical operation control command or the like.

The gateway 120 includes a gateway function unit 121 and a gateway information storage unit 122. The gateway function unit 121 performs gateway processing between the control network, which is an upper network, and the wireless network. Thus, the gateway function unit 121 performs exchange of packets with each of the wireless field devices 200 via the wireless network. The gateway information storage unit 122 is a storage area that stores, for example, address information required for gateway processing.

The system manager 140 includes a network management unit 141, a network configuration collection unit 142, a path selection unit 143, and a communication unit 144.

The network management unit 141 performs control and management of operation of the wireless network.

The communication unit 144 performs a communication process with the gateway 120, the backbone router 180 and the like.

The network configuration collection unit 142 collects connection configuration information of the wireless field devices 200 included in the wireless network. Information indicating the wireless field device 200 with which each of the wireless field devices 200 can communicate is contained in the connection configuration information of the wireless field device 200.

Based on the connection configuration information of the wireless field device 200 collected by the network configuration collection unit 142, the path selection unit 143 selects relay paths of a packet destined for each of the wireless field devices 200. In the first preferred embodiment, two paths are selected as the relay paths. However, the number of selected relay paths is not limited to two, and three or more relay paths may be selected. A plurality of relay paths are selected so as not to include the same nodes and the same links as much as possible. The node refers to a communication relay point, and is the wireless field device 200 serving as the relay point. The link refers to a communication path for packets between the nodes, and is a path between two wireless field devices 200.

Transmission of packets along the selected relay paths may be performed using any of source routing and graph routing. Further, a routing method with both the source routing and the graph routing may be used.

In the source routing, the wireless field device 200 stores, as relay information, identification information of the wireless field devices 200 included in the selected relay path, in the packet to be transmitted, in an order in which the packet passes through the wireless field devices 200. The wireless field device 200 receiving the packet transmits the packet to the wireless field device 200 of the next stage by referring to the relay information stored in the packet. Here, the wireless field device 200 of the next stage refers to the wireless field device 200 to which the wireless field device 200 transmits the packet based on the relay path. The selected relay path is set in the backbone router 180 as relay information.

In the graph routing, the system manager 140 defines the selected relay path in a graph form and stores the relay path as graph information in each of the wireless field devices 200. In the graph information stored in each of the wireless field devices 200, a graph to be used for each packet is designated. When the packet is received, the wireless field device 200 transmits the packet to the wireless field device 200 of the next stage along the graph designated in the packet by referring to the graph information stored in the wireless field device 200. Here, the wireless field device 200 of the next stage refers to the wireless field device 200 to which the wireless field device 200 transmits the packet based on the graph. The selected relay path is set to the backbone router 180 as relay information. In the case of the graph routing, the graph information is stored in each of the wireless field devices 200.

Here, the function of the system manager 140 may be caused to be included in the gateway 120 to constitute the system manager 140 and the gateway 120 as an integral unit.

The backbone router 180 includes a communication unit 181, a relay information storage unit 182, a path selection unit 183, and a packet processing unit 184.

The communication unit 181 performs a process of communication with the gateway 120 and the system manager 140. Also, the communication unit 181 performs a wireless communication process with the adjacent wireless field device 200.

The relay information storage unit 182 is a storage area for storing relay information of the path selected by the system manager 140.

The path selection unit 183 sets the relay paths along which the packet is transmitted based on the destination of the packet and the relay information stored in the relay information storage unit 182. The set relay paths are two relay paths selected for each wireless field device 200, which is the destination of the packet, by the path selection unit 143 of the system manager 140.

In order to transmit the packet destined for the wireless field device 200 received from the gateway 120 along the two set relay paths, the packet processing unit 184 replicates the packet. A first packet is assumed to be transmitted along the first relay path, and a second packet is assumed to be transmitted along a second relay path. In the case of the source routing, the packet processing unit 184 stores the first relay path as the relay information in the first packet and stores the second relay path as the relay information in the second packet. In the case of the graph routing, the packet processing unit 184 designates, in the first packet, a graph to be used as the first relay path and designates, in the second packet, a graph to be used as the second relay path, in the graph information stored in each of the wireless field devices 200.

The communication unit 181 transmits the packet to the wireless field device 200 of the next stage in each relay path over the wireless network according to the relay information. Each wireless field device 200 receiving the packet transmits the packet to the wireless field device 200 of the next stage in each relay path over the wireless network according to the relay information. That is, in the first preferred embodiment, the two replicated packets are transmitted to the destination along the two relay paths. Thus, even when one of the relay paths has been broken, the packet can arrive at the wireless field device 200 that is the destination. In this case, the wireless field device 200 may perform a transmission process similar to that in the related art. It is desirable for the two relay paths to be selected so that the link between one node (the wireless field device 200) and the other node does not overlap as much as possible. Thus, when abnormality occurs in the path between the wireless field devices 200 due to failure or weak radio waves, as well as when an abnormality occurs in the relaying wireless field device 200 itself, the packet can be caused to arrive at the wireless field device 200 that is the destination.

The wireless field device includes a wireless communication unit 201, a relay information storage unit 202, a packet processing unit 203, and a measurement and operation unit 204.

The wireless communication unit 201 performs communication with the adjacent wireless field device 200 and the backbone router 180 using protocol conforming to the ISA100.11a.

The measurement and operation unit 204 performs processing according to the type of wireless field device 200, such as a sensor or an actuator.

In the case of the graph routing, the relay information storage unit 202 is a storage area for storing the graph selected by the system manager 140 as graph information. The relay information storage unit 202 may also store a transmission destination of the packet corresponding to the graph to be used.

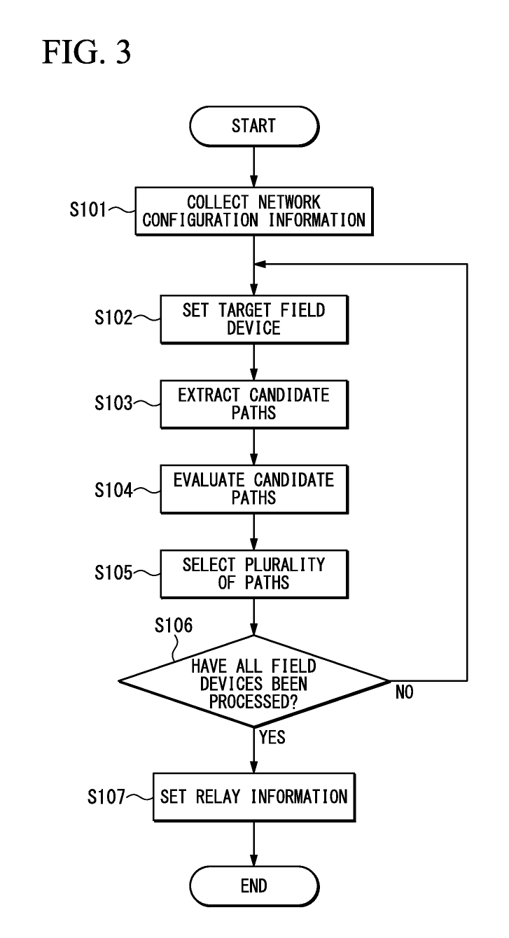

When a packet destined for the wireless field device 200 is received, the packet processing unit 203 performs a process of discarding the packet if the packet is a previously received packet by referring to a sequence number of the packet. In the first preferred embodiment, the replicated packets are transmitted via two different relay paths. Accordingly, if the two relay paths are normal, the wireless field device 200 that is the destination receives the same packet twice. For this reason, an early arriving packet may be received and a late arriving packet may be discarded. Next, a path selection operation of the system manager 140 will be described with reference to a flowchart of FIG. 3. FIG. 3 is a flowchart illustrating the path selection operation of the system manager in the field wireless system in accordance with the first preferred embodiment of the present invention. In step S101, the network configuration collection unit 142 collects connection configuration information of the wireless network in the path selection operation. Accordingly, the wireless field device 200 and the wireless field device 200 that can communicate with each other are recognized.

When the configuration information of the wireless network is collected, the path selection unit 143 sets the wireless field device 200 that is a path selection target in step S102. The wireless field device 200 that is the selection target may be set in a predetermined order.

Then, in step S103, candidate paths from the gateway 120 to the wireless field device 200, which is the selection target, are extracted. The extraction of the candidate paths is done by listing all possible paths from the gateway 120 to the wireless field device 200, which is the selection target, in a mesh-shaped network connection configuration. Here, a path including overlapping nodes is not to be included in the candidate paths.

If the candidate paths are extracted, two of the candidate paths are combined into a pair and evaluation is performed on all pairs in step S104. In step S105, the two paths are selected. It is desirable for a link between one node (the wireless field device 200) and the other node not to overlap as much as possible in the selected paths, and a path having a small number of hops is good. Accordingly, the two paths may be selected, for example, by performing evaluation using the following algorithm. The number of hops refers to the number of relay points (nodes) in the relay path.

That is, for a pair of candidate path A and candidate path B, a negative evaluation value increments for one overlapping wireless field device and a negative evaluation value increments for one overlapping link. This evaluation is performed on all the pairs of candidate paths, and two candidate paths of the pair having the smallest negative evaluation value are selected as the above two paths. If there are a plurality of pairs having the smallest negative evaluation values, the pair, of which sum of the numbers of hops of the respective candidate paths is smaller, may be selected as the paths. However, the two paths may be selected using other algorithms.

For example, in the example of the network connection configuration illustrated in FIG. 1, when the wireless field device 200e is the selection target, two paths (bold dotted lines in the FIG. 1): “backbone router 180→wireless field device 200a→wireless field device 200c→wireless field device 200e” and “backbone router 180→wireless field device 200b→wireless field device 200g→wireless field device 200f→wireless field device 200e” may be selected.

In step S106, the process of selecting the two paths (steps S102 to S105) is repeated for all wireless field devices 200. When the process of selecting the two paths ends for all the wireless field devices 200 (Yes in step S106), relay information corresponding to the selected path is set in the relay information storage unit 182 of the backbone router 180 in step S107. In addition, in the case of graph routing, graph information is stored in the relay information storage unit 202 of each wireless field device 200.

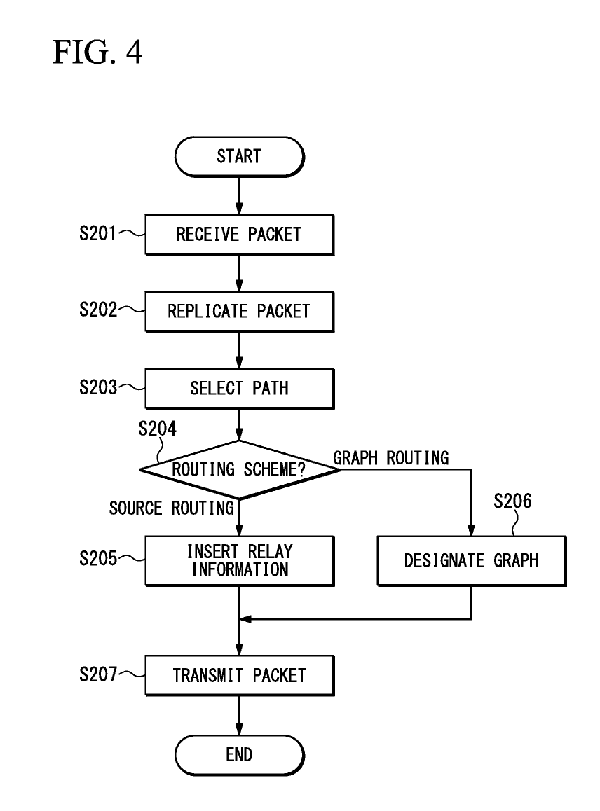

Next, a routing operation of the backbone router 180 will be described with reference to a flowchart of FIG. 4. FIG. 4 is a flowchart illustrating a routing operation of the backbone router included in the field wireless system in accordance with the first preferred embodiment of the present invention. When receiving a packet from the gateway 120 in step S201, the packet processing unit 184 of the backbone router 180 replicates the received packet in order to transmit the packet along the two paths in step S202.

Further, in step S203, the path selection unit 183 selects the path selected for the wireless field device 200 that is the destination of the packet by referring to the relay information stored in the relay information storage unit 182. Path setting according to a routing scheme is then performed in step S204. That is, in the case of a source routing scheme, relay information of one of the two selected paths is inserted into the received packet, and relay information of the other selected path is inserted into the replicated packet in step S205. Further, in the case of a graph routing scheme, a graph to be used for one of the two selected paths is designated in the received packet, and a graph to be used for the other selected packet is designated in the replicated packet in step S206.

Then, the packet is transmitted to the wireless field device 200 of a next stage in each path along the selected path via the communication unit 181 in step S207. Accordingly, it is possible to transmit the same packet along two different paths.

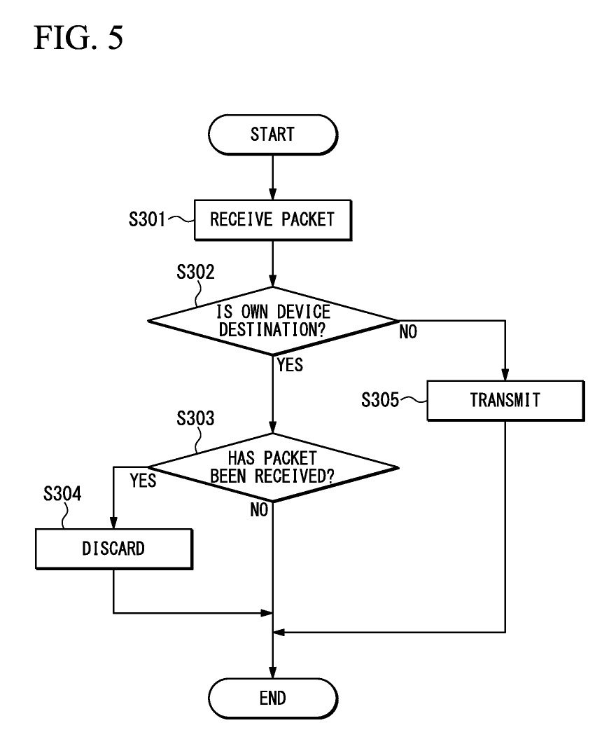

Next, a packet reception operation of the wireless field device 200 will be described with reference to a flowchart of FIG. 5. FIG. 5 is a flowchart illustrating a packet reception operation of the wireless field device included in the field wireless system in accordance with the first preferred embodiment of the present invention. If, in step S301, the wireless field device 200 receives a packet from another wireless field device 200 or the backbone router 180, then, in step S302, the wireless field device 200 determines whether or not a destination of the packet is the own wireless field device.

If the destination is the own wireless field device (Yes in S302), then, in step S303, a determination is made as to whether the packet is a received packet by referring to an identifier of the packet, for example, a sequence number. If the packet is a non-received packet (No in S303), the process of receiving the packet is continued. If the packet is a received packet (Yes in S303), the packet is discarded in step S304.

If the own wireless field device is not the destination (No in S302), the packet is transmitted to the wireless field device 200 of the next stage based on the destination and the relay information in step S305.

Through this operation, even when failure has occurred on the relay path, the wireless field device 200 can receive packets. Accordingly, it is possible to increase the reliability of packet arrival in the field wireless system.

Packet transmission using a plurality of paths may be applied to packet transmission from the wireless field device 200 to the gateway 120 (hereinafter referred to as an uplink direction), such as transmission of measured values. For the uplink path, it is possible to form a hierarchical structure according to the number of hops up to the gateway 120, which is a vertex, for each wireless field device 200 since the destination can be fixed to the gateway 120.

In the example of FIG. 1, since the wireless field device 200a and the wireless field device 200b can communicate with the gateway 120 via two hops, the wireless field device 200a and the wireless field device 200b are a 2-hop hierarchy. The wireless field device 200c, the wireless field device 200g, and the wireless field device 200d are a 3-hop hierarchy. Further, the wireless field device 200e, the wireless field device 200f, and the wireless field device 200h are a 4-hop hierarchy.

Thus, as the relay information of each wireless field device 200, the system manager 140 sets two upper wireless field devices 200 that can communicate with the wireless field device 200 as transmission destinations. In this case, one of the destinations is for a main path, and the other destination is for an auxiliary path. If there is only one upper wireless field device 200 that can communicate with the wireless field device 200, a wireless field device 200 on the same level may be the auxiliary path.

When the wireless field device 200 transmits or transfers a packet, the wireless field device 200 first transmits the packet to a wireless field device 200 on the main path. If the transmission fails due to abnormality on the main path or failure of the wireless field device 200 that is the destination, the packet may be transmitted to a wireless field device 200 on the auxiliary path. Thus, it is possible for packets to arrive at the gateway 120 without being lost because a normal path can be relayed even when the one path fails.

In addition, in the case of downlink packet transmission, it is not realistic to form a hierarchical structure in which a destination is a vertex for all wireless field devices 200 and then set the main path and the auxiliary path since a wireless field device 200 that is the destination is variable. Therefore, for the downlink packet transmission, a packet is simultaneously transmitted to a plurality of paths, as described above.

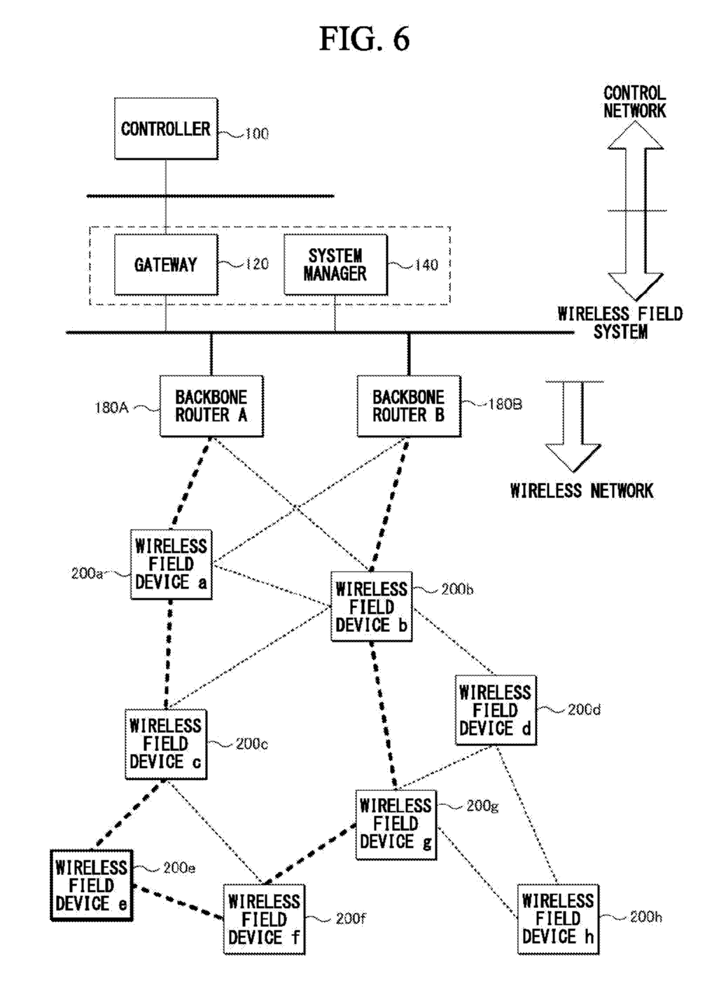

Next, a case in which there are a plurality of backbone routers 180 as illustrated in FIG. 6 will be described as another example of the first preferred embodiment. FIG. 6 is a diagram illustrating another configuration example of the field wireless system in accordance with the first preferred embodiment of the present invention. Here, two of a backbone router 180A and a backbone router 180B are illustrated to be included in the wireless network.

When there is one backbone router 180, the backbone router 180 replicates a packet to flow along the two paths, as illustrated by the bold dotted lines in FIG. 1. When there are two backbone routers 180, the gateway 120 replicates a packet and transmits the packet to the two backbone routers 180 to flow along the two paths, as illustrated by the bold dotted lines in FIG. 6. Thus, even when one backbone router 180 fails, it is possible to cause the packet to arrive at the wireless field device 200 that is the destination.

In this case, the system manager 140 selects one path for each of the two backbone routers. In a pair of the paths, it is desirable that a link between one node and the other node not overlap as much as possible and a total number of hops be small. The system manager 140 also stores selected path information in the gateway information storage unit 122 of the gateway 120.

Also, the gateway 120 may perform the operation of the backbone router 180 shown in the flowchart of FIG. 4. That is, when the gateway 120 transmits a packet to the wireless field device 200, the gateway 120 replicates the packet, selects a path according to the destination, and sets the path in the packet. Then, the one of the packets flows to the backbone router 180A, and the other packet flows to the backbone router 180B.

Meanwhile, the backbone router 180 may transmit the received packet to one wireless field device 200 according to relay information without replicating the received packet.

Thus, even when failure has occurred on the relay path including the backbone router 180, the wireless field device 200 can receive packets. Accordingly, it is possible to increase the reliability of packet arrival in the field wireless system.

As used herein, the following directional terms “forward, rearward, above, downward, right, left, vertical, horizontal, below, transverse, row and column” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. A field wireless system comprising:
a system manager that manages a wireless network including wireless field devices; and
a backbone router that performs wireless communication with the wireless field devices, wherein
the system manager comprises:
a network configuration collection unit that collects a connection configuration of the wireless network; and
a path selection unit that selects relay paths for each of the wireless field devices that is a destination of a packet, based on the connection configuration that has been collected, and
the backbone router comprises:
a relay information storage unit that stores the relay paths that have been selected; and
a packet processing unit that replicates packets, each of which is destined for each of the wireless field devices, by the number of the relay paths that have been stored, the packet processing unit storing information indicating a different relay path in each of the packets that have been replicated.

2. The field wireless system according to claim 1, wherein the path selection unit:
takes a plurality of paths from a set of candidate paths, as combinations;
performs evaluation on each of the combinations by using an evaluation scheme, in which an evaluation increases as the number of overlaps of links between the wireless field devices on paths, which are included in each of the combinations, decreases; and
selects one of the combinations having a highest evaluation as the relay path.

3. The field wireless system according to claim 2, wherein the evaluation scheme comprises:
taking, as the evaluation, a step of incrementing a negative evaluation value for one overlapping wireless field device in the plurality of paths included in each of the combinations and incrementing a negative evaluation value for one link between the overlapping wireless field devices; and
performing the evaluation on all of the combinations and selecting, as the relay path, one of the combinations having the smallest negative evaluation value.

4. The field wireless system according to claim 3, wherein,
if there are a plurality of combinations having the smallest evaluation value, then each of the combinations having a smaller total number of links between the wireless field devices on the paths, which is included in each of the combinations, is selected as the relay path.

5. A field wireless system comprising:
wireless field devices;
a system manager that manages a wireless network including the wireless field devices; and
a backbone router that performs wireless communication with the wireless field devices, wherein
the system manager comprises:
a network configuration collection unit that collects a connection configuration of the wireless network; and
a path selection unit that selects relay paths for each of the wireless field devices that is a destination of a packet, based on the connection configuration that has been collected,
the backbone router comprises:
a relay information storage unit that stores the relay paths that have been selected; and
a packet processing unit that replicates packets, each of which is destined for each of the wireless field devices, by the number of the relay paths that have been stored, the packet processing unit storing information indicating a different relay path in each of the packets that have been replicated, and
each of the wireless field devices discards a newly received packet if the wireless field device has received a packet having the same identifier when receiving packet destined for the own wireless field device.

6. The field wireless system according to claim 5, wherein
the system manager sets, in each of the wireless field devices, a plurality of upper wireless field devices to which a packet destined for an upper network device is capable of being transmitted, and
the wireless field device transmits the packet destined for an upper network device to one of the set upper wireless field devices, and transmits the packet to another set upper wireless field device when the transmission is incapable of being performed.

7. The field wireless system according to claim 5, wherein
the system manager stores identification information of the wireless field devices included in the relay path, in the packet, in an order in which the packet passes through the wireless field devices.

8. The field wireless system according to claim 7, wherein
each of the wireless field devices transmits the packet to another wireless field device based on the identification information stored in the received packet.

9. The field wireless system according to claim 5, wherein
the system manager defines the relay path in a graph form and stores the relay path in each of the wireless field devices as graph information.

10. The field wireless system according to claim 9, wherein
each of the wireless field devices transmits the packet to another wireless field device according to the graph designated in the received packet by referring to the graph information stored in the own wireless field device.

11. A wireless network management method for managing a wireless network including wireless field devices, the method comprising:
collecting a connection configuration of the wireless network;
selecting relay paths for each of the wireless field devices that is a destination of a packet based on the connection configuration that has been collected;
storing the relay paths that have been selected;
replicating packets, each of which is destined for the wireless field device, by the number of relay paths that have been stored; and
storing information indicating a different relay path in each of the packets that have been replicated.

12. The wireless network management method according to claim 11, further comprising:
taking a plurality of paths from a set of candidate paths, as combinations;
performing evaluation on each of the combinations by using an evaluation scheme, in which an evaluation increases as the number of overlaps of the links between the wireless field devices on paths, which are included in each of the combinations, decreases; and
selecting one of the combinations having a highest evaluation as the relay path.

13. The wireless network management method according to claim 12, wherein the evaluation scheme comprises:
taking, as the evaluation, a step of incrementing a negative evaluation value for one overlapping wireless field device in the plurality of paths included in each of the combinations and incrementing a negative evaluation value for one link between the overlapping wireless field devices; and
performing the evaluation on all of the combinations and selecting, as the relay path, one of the combinations having the smallest negative evaluation value.

14. The wireless network management method according to claim 13, wherein
if there are a plurality of combinations having the smallest evaluation value, then each of the combinations having a smaller total number of links between the wireless field devices on the paths, which is included in the combination, is selected as the relay path.

15. The wireless network management method according to claim 11, further comprising:
discarding a newly received packet if receiving a packet having the same identifier when receiving the packet destined for own wireless field device.

16. The wireless network management method according to claim 11, further comprising:
setting, in the wireless field device, a plurality of upper wireless field devices to which a packet destined for an upper network device is capable of being transmitted; and
transmitting the packet destined for an upper network device to one of the set upper wireless field devices, and transmitting the packet to another set upper wireless field device if the transmission is incapable of being performed.

17. The wireless network management method according to claim 11, further comprising:
storing identification information of the wireless field devices included in the relay path, in the packet, in an order in which the packet passes through the wireless field devices.

18. The wireless network management method according to claim 17, further comprising:
transmitting the packet to another wireless field device based on the identification information stored in the received packet.

19. The wireless network management method according to claim 11, further comprising:
defining the relay path in a graph form and storing the relay path in each of the wireless field devices as graph information.

20. The wireless network management method according to claim 19, further comprising:
transmitting the packet to another wireless field device according to the graph designated in the received packet by referring to the graph information stored in each of the wireless field devices.
